(19) United States
(12) Patent Application Publication
(10) Pub. No.: US 2003/0056423 A1
(43) Pub. Date: Mar. 27, 2003

(54) "Line-locking fishing lure weight with an interchangeable skirt"

(76) Inventor: Bennie B. Baucom, Lakeland, FL (US)

Correspondence Address: George A. BODE, BODE & ASSOCIATES, P.C., 2314 Broadway, New Orleans, LA, 70125-4128, US

(21) Appl. No.: 09/962,669

(22) Filed: Sep. 26, 2001

(51) Int. Cl. A01K 85/00

(52) U.S. Cl. 43/42.39

(57) ABSTRACT

A line-locking fishing lure weight comprising which includes a bullet-shaped weighted body member having a central bore through which fishing line is thread. The weighted body member is adapted with a circumferential groove to interchangeably attach thereto a ring with a plurality of filaments. The bullet-shaped weighted body member is secured to the fishing line via a resilient T-plug. Notches are formed in the top head member of the T-plug which is intended to slip the fishing line therein to balance the bullet-shaped weighted body member.

### BACKGROUND OF THE INVENTION

1. Field of the Invention

The present invention relates to fishing weights and lures and, more particularly, to a line-locking fishing lure weight with an interchangeable shirt which can be used without a hook such as for use as a squid teaser when fishing for marlins, sail fish, trout, bass or other game fish.

2. General Background

There are a variety of teaser designs which attract the attention of game fish. In some instance several teasers are coupled in series along the fishing line to form a teaser rig with the last lure having a hook to catch the game fish. One commonly know teaser is a squid teaser which includes a head followed by a flaring skirt.

U.S. Pat. No. 4,942,689 issued to Dylist, Inc., of Shakopee, Minn., on the application of D. J. Link, et al., entitled “FISHING WEIGHT, ” discloses a fishing weight comprising a bullet-shaped body having a central bore through which a fishing line passes. The base of the bullet-shaped body has a concave cavity, a recess filled with rubber and a spherical cavity molded in the rubber within the recess for accepting the shank and eye of a fishhook. The concave cavity is generally rounded toward the worm so that the head end of the worm conforms to the cavity.

The Bass Pro Catalogue@Page 116 discloses the Bass Pro “Premium Brass Weights” which comprise a fishing weight having a bullet-shaped brass body portion with a central bore through which a fishing line passes.

The Bass Pro Catalogue@Page 116 further discloses “Peg-it” which includes a fishing sinker and a soft, durable rubber peg which is wedged inside of the sinker and around the line.

The Cabela Catalogue@Page 36 discloses the Cabela “Versatile Rigging System” which comprise a fishing weight having a bullet-shaped body portion with a central bore through which a fishing line passes and a recessed collar or circumferential groove in the peripheral surface of the body for accepting a fish-attracting skirt.

U.S. Pat. No. 5,259,151 issued to J. E. Wicht, entitled “FISH LINE SINKER, ” discloses a fish line sinker comprising a bullet-shaped body having a cylindrical cavity for accepting a cylindrical plug. The bullet-shaped body and cylindrical plug having aligned passages or bores for passing a fishing line therethrough.

U.S. Pat. No. 5,031,351 issued to H. Rogel, entitled “TWO-PIECE SLIP SINKER FOR FISHING”; and, U.S. Pat. No. 5,197,220 issued to Classic Manufacturing Co., Inc., of Clermont, Fla., on the application of L. W. Gibbs, et al., entitled “CHANGEABLE FISHING LINE ATTACHMENTS” each disclose a fishing sinker having different geometrically shaped sinkers or weights and which includes a central bore through which a fishing line passes and a recessed collar or circumferential groove in the peripheral surface of the body.

U.S. Pat. No. 1,313,567 issued to C. B. Ulrich; and, U.S. Pat. No. 5,207,016 issued to W. E. Pate, each disclose a fishing lure with a skirt attached to the surface of the body.

Other patent in the sinker art include U.S. Pat. No. 4,472,903 issued to D. Hutson, entitled “FISHING WEIGHT”; and, U.S. Pat. No. 4,965,956, issued to Bethel, entitled “CAM ACTION FISHING SINKER DEVICE” each discloses various fishing weight or sinker designs.

As can be appreciated, there is a continuing need for a line-locking fishing lure weight with an interchangeable shirt which is used without a hook such as for use as a squid teaser when fishing for marlins, sail fish, trout, bass or other game fish wherein the skirt can be interchanged to accommodate for a variety of species easily and quickly.

Furthermore, there is a continuing need for a line-locking fishing lure weight which functions as a teaser and which limits line twisting.

Moreover, there is a continuing need for a line-locking fishing lure weight which functions as a teaser and which is not generally susceptible to damage.

Moreover, there is a continuing need for a line-locking fishing lure weight which includes a removably resilient T-plug to vary the placement of such weight along the fishing line on demand. The T-plug includes a head member with at least one notch formed in the head member's peripheral surface and which extends inward toward the longitudinal axis of the T-plug so that the fishing line is capable of moving closer toward the longitudinal axis of the T-plug to balance the fishing lure weight.

As will be seen more fully below, the present invention is substantially different in structure, methodology and approach from that of the prior fishing lure weights.

### SUMMARY OF THE PRESENT INVENTION

The preferred embodiment of the line-locking fishing lure weight of the present invention solves the aforementioned problems in a straight forward and simple manner.

Broadly, the present invention contemplates a hook-less line-locking fishing lure weight comprising: a bullet-shaped weighted body member having a central bore formed from a front distal end to a rear distal end; an interchangeable hook-less fishing lure coupled to said bullet-shaped body member; and, a plug having a peg member and a top head member wherein the peg member is adapted to be friction fit coupled in said central bore from said rear distal end and wherein said top head includes a notch formed in a periphery surface of said top head member and extends toward a longitudinal axis of said plug to slip fishing line threaded through said central bore into said notch.

In view of the above, an object of the present invention is to provide a line-locking fishing lure weight with an interchangeable shirt which is used without a hook such as for use as a squid teaser when fishing for marlins, sail fish, trout, bass or other game fish wherein the skirt can be interchanged to accommodate for a variety of species easily and quickly.

A further object of the present invention is to provide a line-locking fishing lure weight which functions as a teaser and which limits line twisting.

A still further object of the present invention is to provide a line-locking fishing lure weight which function as a teaser and which is not generally susceptible to damage.

A still further object of the present invention is to provide a line-locking fishing lure weight which includes a removably resilient T-plug to vary the placement of such weight along the fishing line on demand.

A still further object of the present invention is to provide a line-locking fishing lure weight which includes a T-plug having a head member with at least one notch formed in the head member's peripheral surface and which extends inward toward the longitudinal axis of the T-plug so that the fishing line is capable of moving closer toward the longitudinal axis of the T-plug to balance such fishing lure weight.

A still further object of the present invention is to provide a line-locking fishing lure weight which includes a T-plug which is made of rubber or rubberized plastic to allow it to be friction fit coupled in the central bore of the weight without fraying, nicking or damaging the fishing line when secured.

Furthermore, the present invention contemplates a hook-less line-locking teaser weight comprising: a bullet-shaped weighted body member having a central bore formed from a front distal end to a rear distal end; a circumferential groove formed in a periphery surface of said bullet-shaped body member; a hook-less fishing teaser coupled to said bullet-shaped body member in said circumferential groove; and, a plug having a peg member and a top head member wherein the peg member is adapted to be friction fit coupled in said central bore from said rear distal end and wherein said top head includes a notch formed in a periphery surface of said top head member and extends toward a longitudinal axis of said plug to slip fishing line into said notch.

In view of the above, a feature of the present invention is to provide a line-locking fishing lure weight which is simple to install and use.

A further feature of the present invention is to provide a line-locking fishing lure weight which is relatively simple structurally and thus simple to manufacture.

The above and other objects and features of the present invention will become apparent from the drawings, the description given herein, and the appended claims.

### BRIEF DESCRIPTION OF THE DRAWING

For a further understanding of the nature and objects of the present invention, reference should be had to the following description taken in conjunction with the accompanying drawings in which like parts are given like reference numerals and, wherein:

FIG. 1 illustrates an perspective view of the line-locking fishing lure weight with an interchangeable skirt of the present invention;

FIG. 2 illustrates a cross sectional view of the line-locking fishing lure weight with an interchangeable of the present invention and with the T-plug removed;

FIG. 3 illustrates an end view of the end of the line-locking fishing lure weight with the fishing line journalled in the central bore and the T-plug being inserted into the central bore; and,

FIG. 4 illustrates a perspective view of the T-plug of the present invention;

FIG. 5 illustrates a cross sectional view along the plane 5-5 of the embodiment of FIG. 1.

FIG. 6 illustrates a cross sectional view along the plane 6-6 of the embodiment of FIG. 4.

### DETAILED DESCRIPTION OF THE PREFERRED EMBODIMENT

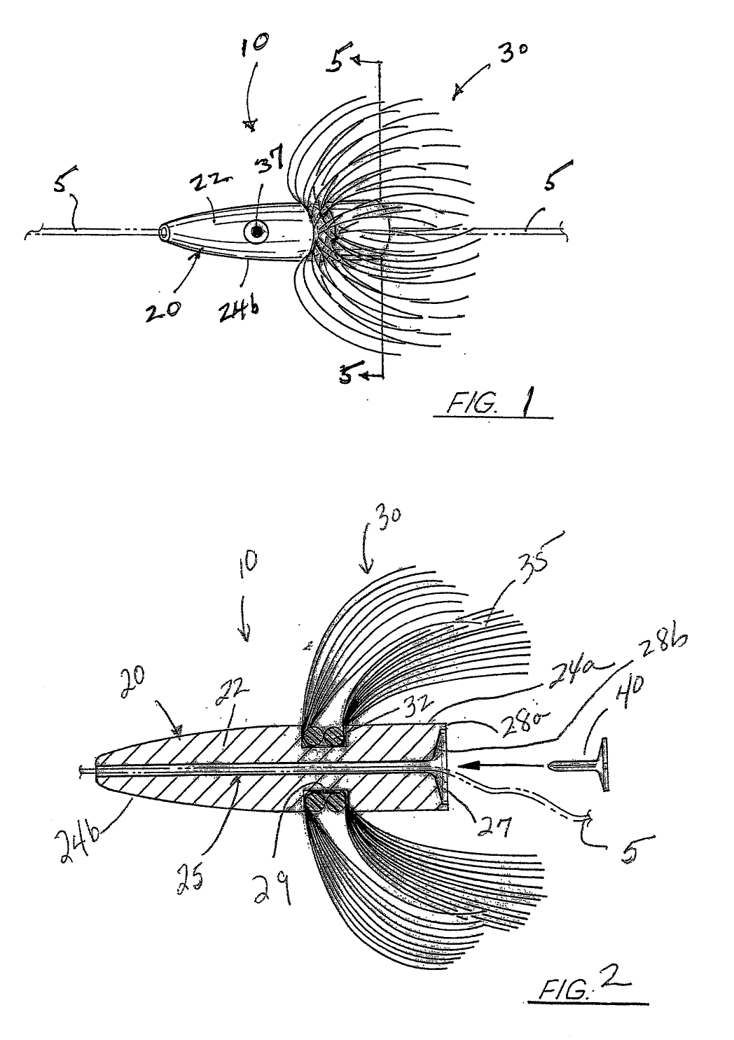

Referring now to the drawings and in particular FIGS. 1-3, the line-locking fishing lure weight of the present invention is generally referenced by the numeral 10. The line-locking fishing lure weight 10 in general integrates a fishing lure or teaser 30 with a weight or sinker 20 and includes a T-plug 40 which friction fit couples or locks the weight or sinker 20 on fishing line 5 threaded through a central bore 25 of the weight or sinker 20.

The weight or sinker 20 includes weight body member 22 having the central bore 25 formed therein along the central longitudinal axis thereof. The weight or sinker 20 includes a rear end 24a having formed therein a cavity 27 constructed and arranged to receive the T-plug 40. The cavity 27 is integral with the central bore 25. Furthermore, the weight structure or body member 22 has formed therein a circumferential groove or channel 29 for securing or attaching fishing lure or teaser 30 therein.

In the preferred embodiment, the weight body member 22 is made of a heavy metal or the like such as without limitation, brass or lead or dense plastic. The weight body member 22 has a general bullet shape wherein the front end 24b circumferentially tapers toward the central bore 25 so as to resemble the anatomic profile of a fishing bait or teaser, such as squid or the like.

The cavity 27 is a beveled concave cavity with defines a rear perimeter rim 28a and a tapering or beveled surface 28b which tapers or slopes toward the central bore 25.

The fishing lure or teaser 30 includes a resilient ring 32 and a plurality of filaments 35 wherein the resilient ring 32 is adapted to be secured in the circumferential groove or channel 29 while the plurality of filaments 35 function as a flaring fish-attracting skirt.

In the exemplary embodiment, the resilient ring 32 is made of rubber or rubberized plastic which is resilient and flexible to enable the fishing lure or teaser 30 to be removed and interchanged with another fishing lure or teaser 30. The fishing lure or teaser 30 preferably further includes opposing eyes 37 integrated, painted or affixed to the front end 24b. In the exemplary embodiment, the fishing lure or teaser 30 is hook-less.

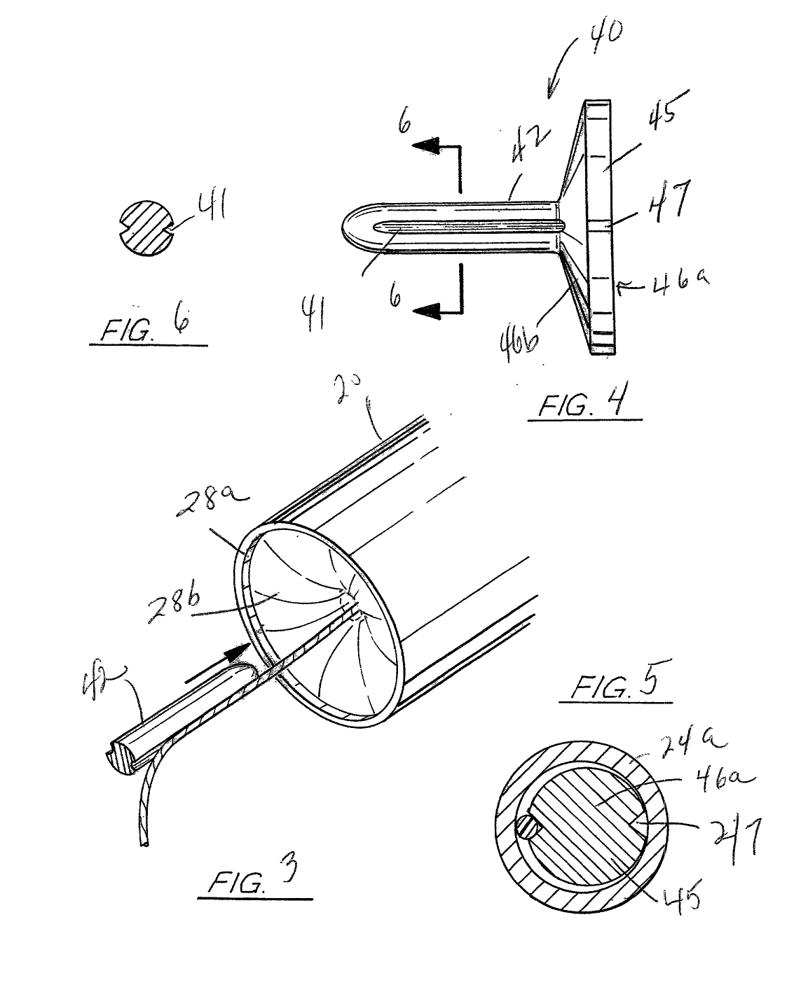

Referring now to FIGS. 4-6, the T-plug 40 includes a peg member 42 and a top head member 45 wherein the peg member 42 is adapted to be friction fit coupled in the central bore 25. Likewise, the top head member 45 is adapted to be friction fit coupled in the cavity 27.

The top head member 45 has a top surface 46a which is generally circular and flat and a bottom surface 47b which is generally conical or tapered to match the beveled concavity of cavity 27. The top head member 45 further includes at least one notch 47 formed in the head member's peripheral surface and which extends inward toward the longitudinal axis of the T-plug 40. The fishing line 5 is capable of being slipped in the notch 47 to move closer toward the longitudinal axis of the T-plug 40 and to balance the fishing line 5 about the fishing lure weight 10.

Preferably the T-plug 40 is made of rubber or rubberized plastic which allows the peg member 42 to be friction fit coupled in the central bore 25 without fraying, nicking or damaging the fishing line when secured. The resilient properties of the T-plug 40 provide a secure friction fit coupling but also adapts or flexes around the fishing line 5 to prevent damage thereto such as when the fishing line 5 is slipped in the notch 47.

In the exemplary embodiment, there are two diametrically opposing notches 47. In the exemplary embodiment, the peg member 42 may have elongated grooves 41 formed therein for placement of the fishing line 5, as best seen in FIGS. 4 and 6.

During installation, the T-plug 40 is removed from the central bore 25 and the fishing line 5 is passed or threaded through central bore 25. The fishing lure weight 10 is slid along the fishing line 5 to the desired location. Once the fishing lure weight 10 is in place, the T-plug 40 should be reinserted into the central bore 25 until the top head member 45 is received in cavity 27. Preferably, prior to reinserting the T-plug 40, the fishing line 5 should be slip into one of the notches 47. Now the angler has a weighted fishing line and a lure or teaser 30 to attract and catch fish.

As can be readily seen, when the T-plug 40 is inserted in rear end 24a it binds the fishing line 5 against the surface of the central bore 25 and thereby provides a means for preventing the weight or sinker 20 from sliding along the fishing line 5 hence, the fishing lure weight 10 is “locked in place.”

Because many varying and differing embodiments may be made within the scope of the inventive concept herein taught and because many modifications may be made in the embodiment herein detailed in accordance with the descriptive requirement of the law, it is to be understood that the details herein are to be interpreted as illustrative and not in a limiting sense.

What is claimed as invention is:

1. A hook-less line-locking fishing lure weight comprising:
(a) a bullet-shaped weighted body member having a central bore formed from a front distal end to a rear distal end;
(b) an interchangeable hook-less fishing lure coupled to said bullet-shaped body member; and,
(c) a plug having a peg member and a top head member wherein the peg member is adapted to be friction fit coupled in said central bore from said rear distal end and wherein said top head includes a notch formed in a periphery surface of said top head member and extends toward a longitudinal axis of said plug to slip fishing line threaded through said central bore into said notch.

2. The weight of claim 1, wherein said plug is made of rubber or a resiliently flexible material.

3. The weight of claim 2, wherein:
said peg member comprises a slender cylindrical member; and,
said top head member comprises a top substantially circularly flat surface and a tapering bottom surface tapering from said periphery surface to said slender cylindrical member.

4. The weight of claim 1, further comprising a circumferential groove formed in a periphery surface of said bullet-shaped body member; and
wherein said interchangeable hook-less fishing lure comprises:
a resilient ring; and,
a plurality of filaments wherein the resilient ring is adapted to be secured in the circumferential groove while the plurality of filaments function as a flaring fish-attracting skirt.

5. The weight of claim 4, wherein said bullet-shaped body member is made of brass, lead or other heavy metal.

6. The weight of claim 1, wherein said bullet-shaped body member further comprises:
a front end which circumferentially tapers toward the central bore at said front distal end and which resembles an anatomic profile of fishing bait; and,
a beveled concave cavity formed in said rear distal end and which integrally merges with said central bore.

7. The weight of claim 1, wherein:
said bullet-shaped body member further comprises:
a front end which circumferentially tapers toward the central bore at said front distal end and which resembles an anatomic profile of fishing bait; and,
said interchangeable hook-less fishing lure comprises:
an interchangeable flaring skirt of a plurality of filaments; and,
an diametrically opposing fish bait eyes coupled to said front end.

8. A hook-less line-locking teaser weight comprising:
(a) a bullet-shaped weighted body member having a central bore formed from a front distal end to a rear distal end;
(b) a circumferential groove formed in a periphery surface of said bullet-shaped body member;
(c) a hook-less fishing teaser coupled to said bullet-shaped body member in said circumferential groove; and,
(d) a plug having a peg member and a top head member wherein the peg member is adapted to be friction fit coupled in said central bore from said rear distal end and wherein said top head includes a notch formed in a periphery surface of said top head member and extends toward a longitudinal axis of said plug to slip fishing line into said notch.

9. The weight of claim 8, wherein said plug is made of rubber or a resiliently flexible material.

10. The weight of claim 9, wherein:
said peg member comprises a slender cylindrical member; and,
said top head member comprises a top substantially i15 circularly flat surface and a tapering bottom surface tapering from said periphery surface to said slender cylindrical member.

11. The weight of claim 8, wherein said hook-less teaser comprises:
a resilient ring; and,
a plurality of filaments wherein the resilient ring is adapted to be secured in the circumferential groove while the plurality of filaments function as a flaring fish-attracting skirt.

12. The weight of claim 8, wherein said bullet-shaped body member is made of brass, lead or other heavy metal.

13. The weight of claim 8, wherein said bullet-shaped body member further comprises:
a front end which circumferentially tapers toward the central bore at said front distal end and which resembles an anatomic profile of fishing bait; and,
a beveled concave cavity formed in said rear distal end and which integrally merges with said central bore.

14. The weight of claim 8, wherein:
said bullet-shaped body member further comprises:
a front end which circumferentially tapers toward the central bore at said front distal end and which resembles an anatomic profile of fishing bait; and,
said hook-less teaser comprises:
an interchangeable flaring skirt of a plurality of filaments; and,
an diametrically opposing fish bait eyes coupled to said front end.

15. A line-locking fishing lure weight comprising:
(a) a means for sinking a fishing line having a central bore formed from a front distal end to a rear distal end;
(b) a circumferential groove formed in a periphery surface of said bullet-shaped body member;
(c) means for teasing or luring fish removably couple to said bullet-shaped body member in said circumferential groove; and,
(d) means for locking a fishing line in said central bore having a peg member and a top head member wherein the peg member is adapted to be friction fit coupled in said central bore from said rear distal end and wherein said top head includes a notch formed in a periphery surface of said top head member and extends toward a longitudinal axis of said plug to slip fishing line threaded through said central bore into said notch.

16. The weight of claim 16, wherein said locking means is made of rubber or a resiliently flexible material.

17. The weight of claim 16, wherein:
said peg member comprises a slender cylindrical member; and,
said top head member comprises a top substantially circularly flat surface and a tapering bottom surface tapering from said periphery surface to said slender cylindrical member.

18. The weight of claim 15, wherein said luring or teasing means comprises:
a resilient ring; and,
a plurality of filaments wherein the resilient ring is adapted to be secured in the circumferential groove while the plurality of filaments function as a flaring fish-attracting skirt.

19. The weight of claim 15, wherein said sinking means further comprises:
a front end which circumferentially tapers toward the central bore at said front distal end and which resembles an anatomic profile of fishing bait; and,
a beveled concave cavity formed in said rear distal end and which integrally merges with said central bore.

20. The weight of claim 15, wherein:
said sinking means further comprises:
a front end which circumferentially tapers toward the central bore at said front distal end and which resembles an anatomic profile of fishing bait; and,
said luring or teaser means comprises:
an interchangeable flaring skirt of a plurality of filaments; and,
an diametrically opposing fish bait eyes coupled to said front end.
